(19) United States
(12) Patent Application Publication
(10) Pub. No.: US 2021/0304328 A1
(43) Pub. Date: Sep. 30, 2021

(54) COMPUTER READABLE RECORDING MEDIUM, SETTLEMENT SYSTEM, AND SETTLEMENT SERVER

(71) Applicant: TOYOTA JIDOSHA KABUSHIKI KAISHA, Toyota-shi (JP)

(72) Inventors: Tomokazu MAYA, Nagoya-shi (JP); Naoki YAMAMURO, Nagoya-shi (JP); Yuki NAKATANI, Tokyo (JP); Kosuke MIYAKE, Tokyo (JP); Soushi MIZUNO, Tokyo (JP); Yasushi FURUHATA, Kodaira-shi (JP); Masataka NARITA, Tokyo (JP); Yasuhiro TAKEHARA, Nagoya-shi (JP)

(73) Assignee: TOYOTA JIDOSHA KABUSHIKI KAISHA, Toyota-shi (JP)

(21) Appl. No.: 17/204,055

(22) Filed: Mar. 17, 2021

(30) Foreign Application Priority Data
Mar. 27, 2020 (JP) 2020-058491

(51) Int. Cl. G06Q 50/06; G06Q 20/28

(52) U.S. Cl. CPC G06Q 50/06; G06Q 20/28

(57) ABSTRACT

A server includes a processor including hardware, the processor being configured to display, on a display, information obtained by converting a balance of a registered prepaid-type settlement method into an amount of an energy source used in life.

The present application claims priority to and incorporates by reference the entire contents of Japanese Patent Application No. 2020-058491 filed in Japan on Mar. 27, 2020.

### BACKGROUND

The present disclosure relates to a computer readable recording medium, a settlement system, and a settlement server.

JP 2009-154901 A discloses a refueling system in which a prepaid-type settlement method is used to perform refueling within the range of a balance.

### SUMMARY

There is a need for a computer readable recording medium, a settlement system, and a settlement server that improve the convenience of a settlement system using a prepaid-type settlement method.

According to one aspect of the present disclosure, there is provided a non-transitory computer-readable recording medium on which an executable program is recorded, the program causing a processor of a computer to execute displaying, on a display, information obtained by converting a balance of a registered prepaid-type settlement method into an amount of an energy source used in life.

### BRIEF DESCRIPTION OF THE DRAWINGS

FIG. 1 schematically illustrates the configuration of a settlement system including a settlement server according to an embodiment;

FIG. 2 is a block diagram schematically illustrating details of each component of the settlement system including the settlement server according to the embodiment;

FIG. 3 schematically illustrates the relation of a settlement method in the settlement system including the settlement server according to the embodiment;

FIG. 4 illustrates one example in which the settlement method is displayed on an operation/display unit of a user terminal in the settlement server according to the embodiment;

FIG. 5 illustrates one example in which a unit price input screen is displayed on the operation/display unit of the user terminal in the settlement server according to the embodiment;

FIG. 6 illustrates one example in which the settlement method is displayed on the operation/display unit of the user terminal in the settlement server according to the embodiment;

FIG. 7 illustrates one example in which the settlement method is displayed on the operation/display unit of the user terminal in the settlement server according to the embodiment;

FIG. 8 illustrates one example in which the settlement method is displayed on the operation/display unit of the user terminal in the settlement server according to the embodiment;

FIG. 9 illustrates one example in which the settlement method is displayed on the operation/display unit of the user terminal in the settlement server according to the embodiment; and

FIG. 10 illustrates one example in which the settlement method is displayed on the operation/display unit of the user terminal in the settlement server according to the embodiment.

### DETAILED DESCRIPTIONS

A computer readable recording medium storing a settlement program, a settlement system, and a settlement server according to an embodiment of the disclosure will be described with reference to the drawings. Note that components in the following embodiment include those that may be easily replaced by those skilled in the art, or those that are substantially the same.

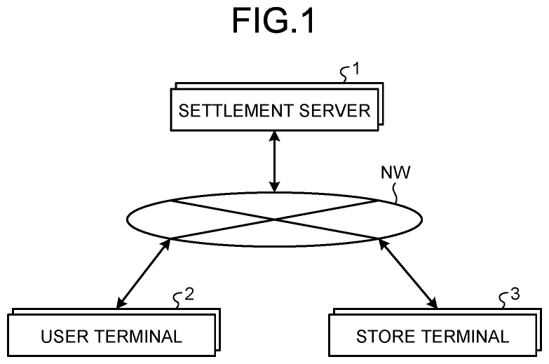

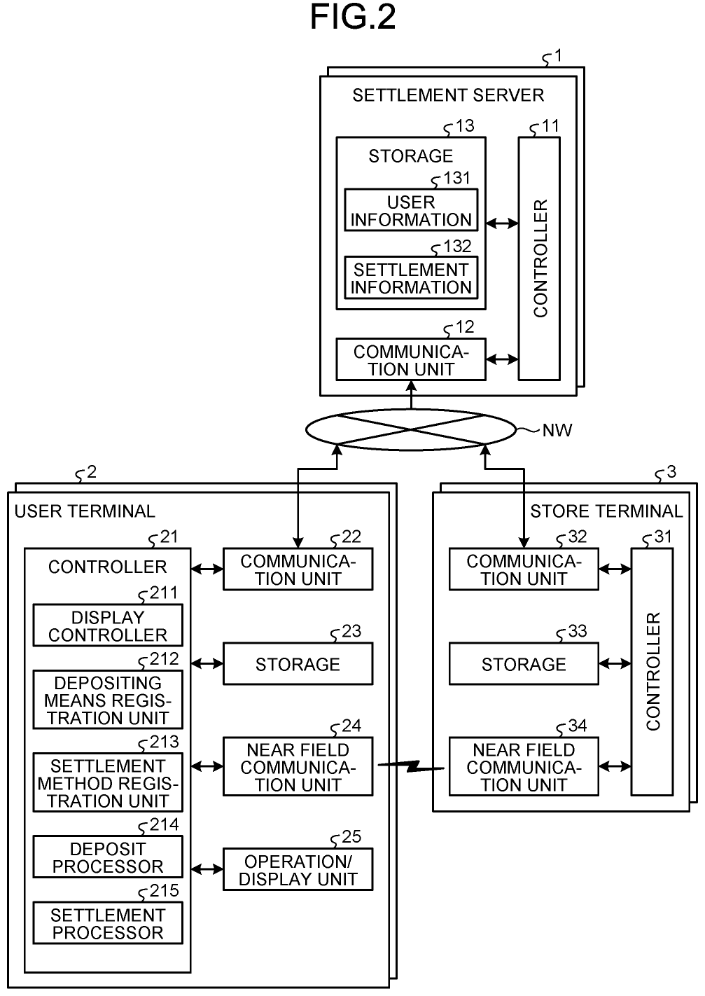

The configuration of the settlement system according to the embodiment will be described with reference to FIGS. 1 and 2. As illustrated in FIG. 1, the settlement system includes a settlement server 1, a user terminal 2, and a store terminal 3.

The settlement server 1, the user terminal 2, and the store terminal 3 may mutually communicate over a network NW. The network NW includes, for example, the internet and a mobile phone network.

The settlement server 1 is used for comprehensively managing the settlement system, and managed by an administrator of the settlement system. As illustrated in FIG. 2, the settlement server 1 includes a controller (first processor) 11, a communication unit 12, and a storage 13. Note that the settlement server 1 may be a wallet server for comprehensively managing a wallet system in which a plurality of settlement means is registered. Note that the wallet is an application for managing virtual deposits and withdrawals by using various settlement methods such as credit cards and electronic money.

Specifically, the controller 11 includes a processor and a memory (main storage). The processor includes, for example, a central processing unit (CPU), a digital signal processor (DSP), and a field-programmable gate array (FPGA). The memory (main storage) includes, for example, a random access memory (RAM) and a read only memory (ROM).

The controller 11 loads a program stored in the storage 13 into a work area of the main storage, and executes the program. The controller 11 implements a function that matches a predetermined purpose by controlling, for example, each component through execution of the program.

The communication unit 12 includes, for example, a local area network (LAN) interface board and a wireless communication circuit for wireless communication. The communication unit 12 is connected to the network NW such as the Internet, which is a public communication network. Then, the communication unit 12 is connected to the network NW to communicate with the user terminal 2 and the store terminal 3.

The storage 13 includes a recording medium such as an erasable programmable ROM (EPROM), a hard disk drive (HDD), and a removable medium. Examples of the removable medium include disc recording media such as a universal serial bus (USB) memory, a compact disc (CD), a digital versatile disc (DVD), and a Blu-ray (registered trademark) disc (BD). The storage 13 may store, for example, an operating system (OS), various programs, various tables, and various databases. The storage 13 according to the embodiment stores user information 131 and settlement information 132 for each user of the settlement system.

The user information 131 relates to a user who uses the settlement system. Examples of the user information 131 include a user ID of a user who has registered to use the settlement system, a password, the name of the user, contact information (e.g., address, telephone number, and e-mail address) of the user, usage registration history, information on a registered settlement method, information on another settlement method registered for performing depositing to the former settlement method, and a personal identification number used at the time of a settlement. Note that the user ID and the password of the user information 131 are used for authentication processing such as login to the settlement server 1.

The settlement information 132 relates to settlement methods in the settlement system. Examples of the settlement information 132 include a user ID, a settlement means used for a settlement (e.g., electronic money payment (contactless settlement), scan payment, and code payment), and settlement history.

The user terminal 2 is a computer terminal used by a user. Examples of the user terminal 2 include smartphones, mobile phones, tablet terminals, wearable computers, personal computers, and vehicle-mounted car navigation systems owned by a user. Any terminal may be used as the user terminal 2 as long as the user terminal 2 may exchange information with the settlement server 1.

The user terminal 2 includes a controller (second processor) 21, a communication unit 22, a storage 23, a near field communication unit 24, and an operation/display unit (display) 25. The controller 21, the communication unit 22, and the storage 23 are physically similar to the controller 11, the communication unit 12, and the storage 13, respectively. The controller 21 functions as a display controller 211, a depositing means registration unit 212, a settlement method registration unit 213, a deposit processor 214, and a settlement processor 215 through the execution of a program.

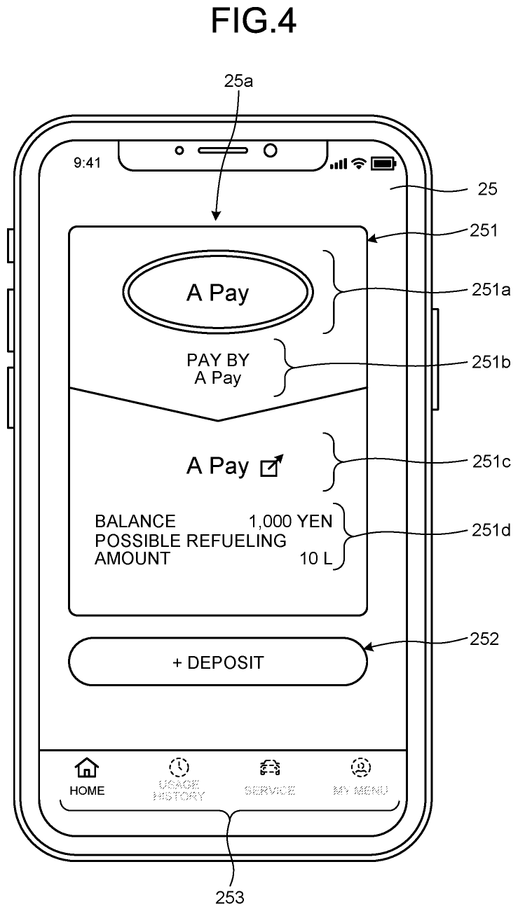

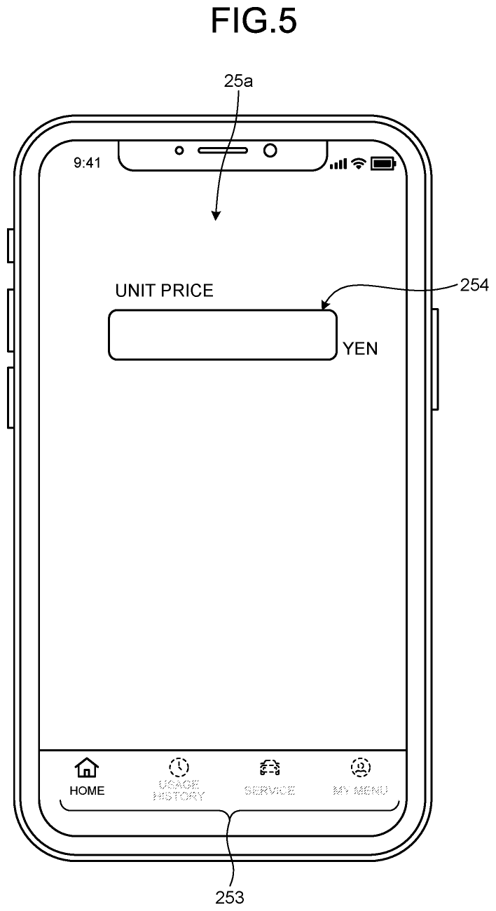

The display controller 211 controls contents displayed on the operation/display unit 25. The display controller 211 displays, on the operation/display unit 25, a member registration screen at the time when a user performs member registration, a login screen at the time of login to the settlement system, a deposit screen at the time of performing depositing to electronic money, a settlement screen 25a (see FIGS. 4 and 6 to 10) at the time of a settlement, a unit price input screen 25b (see FIG. 5) for inputting a unit price, and the like based on a user operation (e.g., touch operation and flick operation). Furthermore, the display controller 211 causes each screen to transition based on a user operation. Note that details of, for example, the settlement screen 25a and the unit price input screen 25b will be described later.

The depositing means registration unit 212 registers a depositing means for depositing electronic money. Specifically, the depositing means registration unit 212 transmits a depositing means registration request to the settlement server 1. The depositing means registration request is used for registering a plurality of different settlement methods (e.g., bank account and credit card) run by a plurality of businesses as depositing means to electronic money. The controller 11 of the settlement server 1, which has received the depositing means registration request from the depositing means registration unit 212, stores a settlement method included in the depositing means registration request in the storage 13 as the user information 131 to register the settlement method as a depositing means.

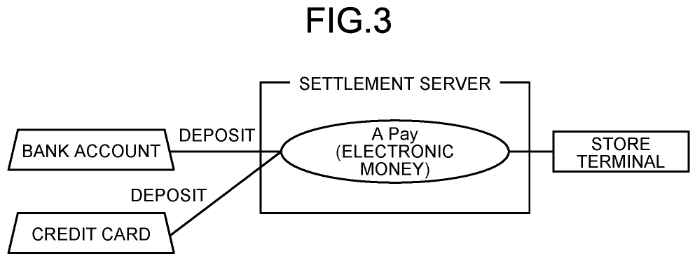

Here, FIG. 3 schematically illustrates the relation of the settlement method in the settlement system. The “settlement method” indicates a payment source (funding source) at the time of a settlement, and here mainly indicates a prepaid-type settlement method in which depositing is preliminarily performed. A depositing means such as a bank account and a credit card, which are means for performing depositing to electronic money, is linked to the settlement method, and depositing to electronic money may be performed. Note, however, that, when the settlement method is of prepaid-type in which depositing is preliminarily performed by, for example, cash, a depositing means such as a bank account and a credit card is not required to be linked to the electronic money.

Then, settlement is made between the user terminal 2 and the store terminal 3 by the settlement method. Specifically, a settlement means is executed between the near field communication unit 24 of the user terminal 2 and a later-described near field communication unit 34 of the store terminal 3 by passing the user terminal 2 over the store terminal 3. The settlement means includes a contactless settlement, a settlement performed by reading a barcode or a QR code® displayed on the store terminal 3 with, for example, a camera of the user terminal 2, and a settlement performed by reading a barcode or a QR code® displayed on the user terminal 2 by, for example, a code reader of the store terminal 3.

The settlement method registration unit 213 registers various settlement methods. The settlement method registration unit 213 transmits a settlement method registration request for registering a settlement method to the settlement server 1. The controller 11 of the settlement server 1, which has received the settlement method registration request from the settlement method registration unit 213, stores a settlement method included in the settlement method registration request in the storage 13 as the user information 131 to register the settlement method as a settlement method.

The deposit processor 214 performs depositing to electronic money. Specifically, the deposit processor 214 transmits a deposit request for performing depositing to electronic money by the settlement method that has been registered as a depositing means to the settlement server 1. The controller 11 of the settlement server 1, which has received the deposit request from the deposit processor 214 increases the balance of electronic money based on deposit amount information included in the deposit request. That is, the controller 11 updates the settlement information 132 stored in the storage 13 in accordance with the increase in the balance of the electronic money.

The settlement processor 215 makes a settlement by the settlement method selected by the user. Specifically, the settlement processor 215 transmits a settlement request to the store terminal 3 through the near field communication unit 24 as a settlement means. Furthermore, the settlement processor 215 may transmit a settlement request to the store terminal 3 by reading a barcode or a QR code® displayed on the store terminal 3 with, for example, a camera of the user terminal 2 as a settlement means. Furthermore, the settlement processor 215 may transmit a settlement request to the store terminal 3 by causing, for example, a code reader of the store terminal 3 to read a barcode or a QR code® displayed on the user terminal 2 as a settlement means. Note that the settlement request transmitted from the settlement processor 215 to the store terminal 3 may include information indicating a settlement amount (hereinafter, referred to as “settlement amount information”), but is not required to include the information.

Subsequently, the settlement processor 215 transmits a settlement request for making a settlement by using a settlement means to the settlement server 1.

Furthermore, the settlement processor 215, in the case of a settlement by using electronic money, a later-described controller 31 of the store terminal 3 transmits a settlement request including settlement amount information to the settlement server 1 via the network NW. The controller 11 of the settlement server 1, which has received the settlement request from the store terminal 3, decreases the balance of electronic money based on settlement amount information included in the settlement request. That is, the controller 11 updates the settlement information 132 stored in the storage 13 in accordance with the decrease in the balance of the electronic money.

The storage 23 stores data of various screens to be displayed by the display controller 211 on the operation/display unit 25. Furthermore, the storage 23 temporarily stores, for example, the user information 131 and the settlement information 132 as needed.

The near field communication unit 24 has a communication function in conformity with a standard such as a near field radio communication (NFC), Bluetooth® low energy (BLE), and infrared data association (IrDA). The user terminal 2 performs near field communication with the store terminal 3 through the near field communication unit 24, for example, when a settlement using electronic money is made.

The operation/display unit 25 includes, for example, a touch panel display. The operation/display unit 25 has an input function and a display function. The input function is used for receiving an operation with, for example, a user finger or a pen. The display function is used for displaying various pieces of information under the control of the display controller 211.

The store terminal 3 is provided in, for example, a store (member store) in which a settlement system may be used. Note, however, that the store terminal 3 may be a server that functions as a virtual store (so-called an electronic commerce site) opened on the Internet. The store terminal 3 includes the controller 31, a communication unit 32, a storage 33, and the near field communication unit 34. The controller 31, the communication unit 32, the storage 33, and the near field communication unit 34 are physically similar to the controller 11, the communication unit 12, the storage 13, and the near field communication unit 24, respectively.

Hereinafter, display control will be described with reference to FIGS. 4 to 10. The display controller 211 performs the display control over the operation/display unit 25 in the settlement system including the settlement server 1 according to the embodiment.

FIG. 4 illustrates one example of the settlement screen 25a displayed on the operation/display unit 25 by the display controller 211. The figure illustrates the settlement screen 25a in the case where “A Pay” is registered as a settlement method in one example. Specifically, the settlement screen 25a includes a settlement means display region 251 displayed in a list, a charge button 252, and a menu switching region 253. The settlement screen 25a is displayed when, for example, an application of a settlement method is opened.

The settlement means display region 251 displays a settlement method, and receives a request for making a settlement by using the displayed settlement method. The display controller 211 displays a settlement name 251a, a settlement phrase 251b, a settlement button 251c, and an additional information region 251d on the settlement means display region 251. The settlement name 251a indicates a name of a settlement method that may be used in the user terminal 2. The settlement phrase 251b clearly indicates that a settlement is made in the settlement method. The settlement button 251c is used for generating a request of a settlement by the settlement means. Additional information on each settlement method is displayed on the additional information region 251d.

Specifically, display is performed as follows in the settlement means display region 251. A mark (e.g., logo mark or acceptance mark) including the name of “A Pay” is displayed as the settlement name 251a. Characters of “Pay by A Pay” are displayed as the settlement phrase 251b. An electronic settlement mark of “A Pay” is displayed as the settlement button 251c. The balance and a possible refueling amount of “A Pay” are displayed as the additional information region 251d.

Here, in FIG. 4, when a user selects the settlement means display region 251 indicating “A Pay”, the display controller 211 displays a preliminarily prepared screen for an electronic settlement. Specifically, the display controller 211 displays, for example, a screen on which a message prompting a contactless settlement between the near field communication unit 24 and the near field communication unit 34 is displayed, a preliminarily prepared screen for scan payment, or a preliminarily prepared screen for code payment.

The display controller 211 displays the balance of electronic money and information obtained by converting the balance into an amount of an energy source used in life on the additional information region 251d as additional information. Specifically, the display controller 211 displays the characters of “balance” and the characters of “1,000 yen” corresponding to the balance of electronic money. Moreover, for example, the information indicates an amount of the balance converted into an energy source. The display controller 211 displays characters of “possible refueling amount” and characters of “10 L”. The “possible refueling amount” indicates an amount of the balance converted into gasoline. The characters of “10 L” corresponds to the possible refueling amount. As a result, the user may preliminarily know the possible refueling amount, so that the convenience is improved. As for the possible refueling amount, the balance is divided by a unit price in a store in which an energy source may be bought. This division enables the balance to be converted into an amount of the energy source by using the unit price. For example, if the unit price per liter of gasoline is 100 yen, the possible refueling amount is calculated by balance 1,000 yen unit price 100 yen to be 10 L. Note that, although an example in which a vehicle is refueled with gasoline will be described here, the disclosure may be applied to the case where a moving object such as a vehicle, a motorcycle, a ship, and an airplane is refueled with an energy source such as gasoline, hydrogen, electricity, and gas.

For example, a user inputs the unit price. For example, the user inputs the unit price in a unit price input field 254 of the unit price input screen 25b illustrated in FIG. 5. When the unit price is input, the settlement screen 25a is displayed, and the display controller 211 displays a balance and a possible refueling amount. Furthermore, the user may select a mark representing a store displayed on a map, and the settlement server 1 may acquire a unit price of the selected store via the network NW. Furthermore, a barcode or a QR code® displayed on the store terminal 3 contains information on a unit price. The unit price may be input to the user terminal 2 by reading the barcode or the QR code® with, for example, a camera of the user terminal 2. Furthermore, the unit price may be acquired by using position information of the user terminal 2. The position information is measured by receiving a signal from a global positioning system (GPS) satellite. For example, when the position information of the user terminal 2 indicates a store presumed to be a gas station, the settlement server 1, which has acquired the position information of the user terminal 2 from the user terminal 2, may acquire the unit price of the store indicated by the position information of the user terminal 2 from, for example, a store server that controls the store terminal 3.

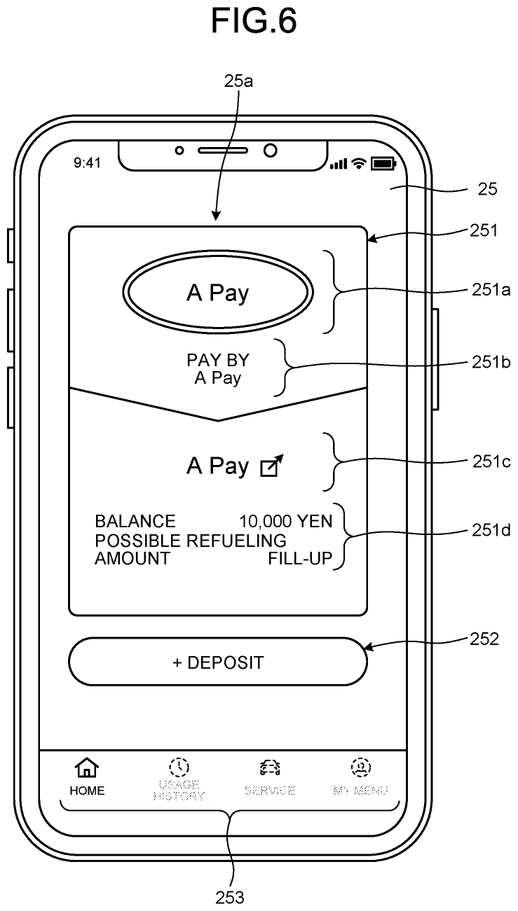

Furthermore, as illustrated in FIG. 6, the display controller 211 may display the fact that filling up a tank is possible by the balance on the additional information region 251d as characters of “fill-up”. As a result, the user may preliminarily know whether he/she may fill up the tank, so that the convenience is improved. Whether or not filling up a tank is possible may be determined by whether or not the sum of the possible refueling amount and the remaining amount of gasoline is larger than the capacity of a refueling tank of a vehicle.

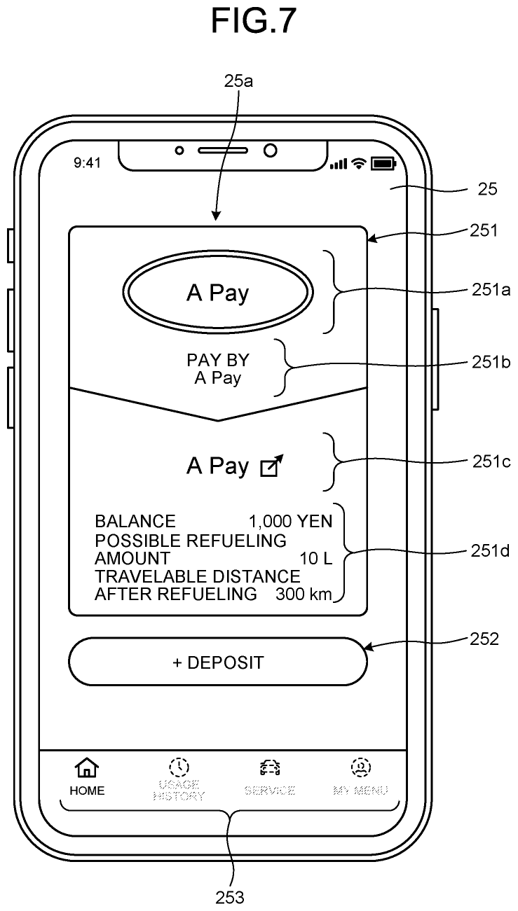

Furthermore, as illustrated in FIG. 7, the display controller 211 may display characters of “travelable distance after refueling” and characters of “300 Km” on the additional information region 251d. The “travelable distance after refueling” corresponds to the distance that may be traveled (moved) by a vehicle in the case where the vehicle is refueled with gasoline of an amount obtained by converting the balance into gasoline. The “300 Km” corresponds to the travelable distance. As a result, the user may preliminarily know the travelable distance after refueling, so that the convenience is improved. The travelable distance after refueling may be calculated by the product of fuel efficiency of a vehicle and a possible refueling amount. The fuel efficiency of a vehicle represents how far the vehicle may travel with gasoline of 1 L. For example, if a vehicle may travel 30 Km with gasoline of 1 L, the travelable distance after refueling is calculated as 300 Km by fuel efficiency 30 Km x possible refueling amount 10 L. Note that, when the travelable distance after refueling is calculated, the user terminal 2 may calculate the travelable distance after refueling by using past travel data of a driver containing, for example, the number of occupants in the vehicle, the weight of a load, and actually measured fuel efficiency. These pieces of data are accumulated by various sensors and storage devices mounted on the vehicle, and are stored in a vehicle or a server connected to the vehicle via a network.

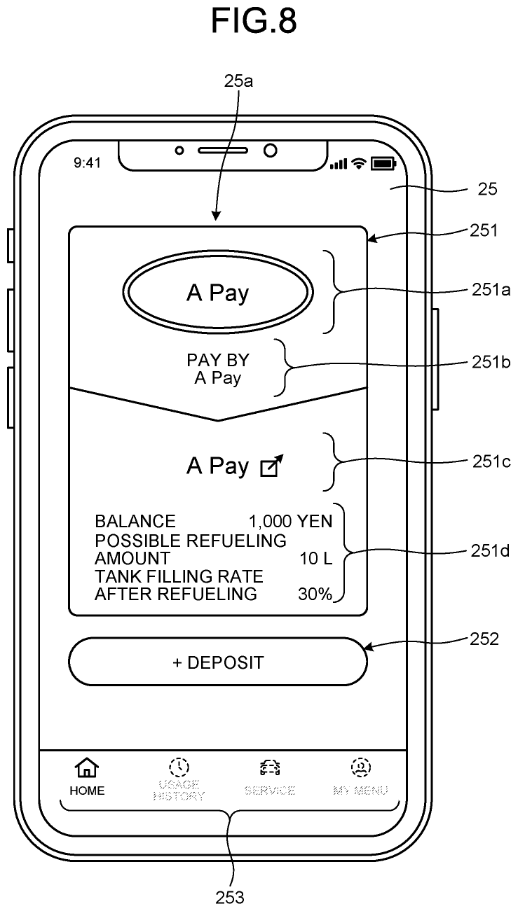

Furthermore, as illustrated in FIG. 8, the display controller 211 may display characters of “tank filling rate after refueling” and characters of “30%” on the additional information region 251d. The “tank filling rate after refueling” corresponds to the filling rate of a refueling tank of the vehicle in the case where the vehicle is refueled with gasoline of an amount obtained by converting the balance into gasoline. The “30%” corresponds to the tank filling rate after refueling. As a result, the user may preliminarily know the tank filling rate after refueling, so that the convenience is improved. The tank filling rate after refueling may be calculated by the ratio of the sum of the remaining amount of gasoline and the possible refueling amount and a vehicle tank capacity.

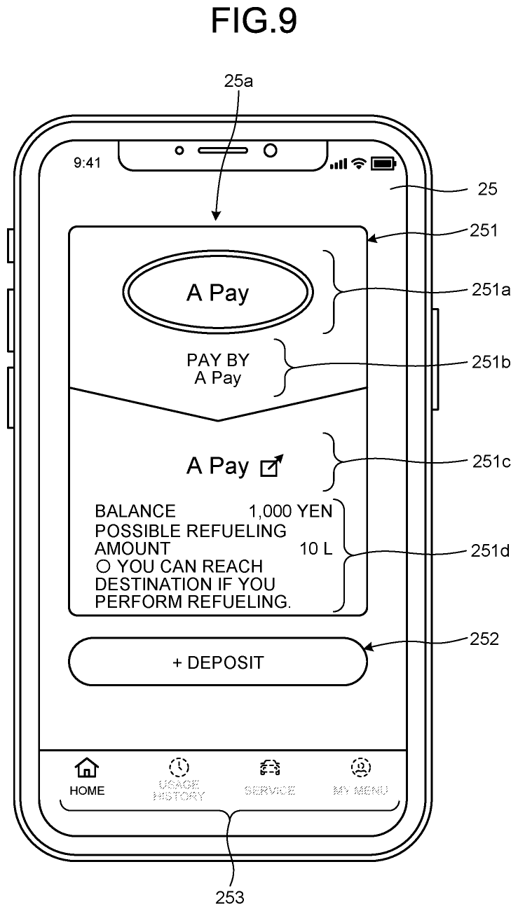

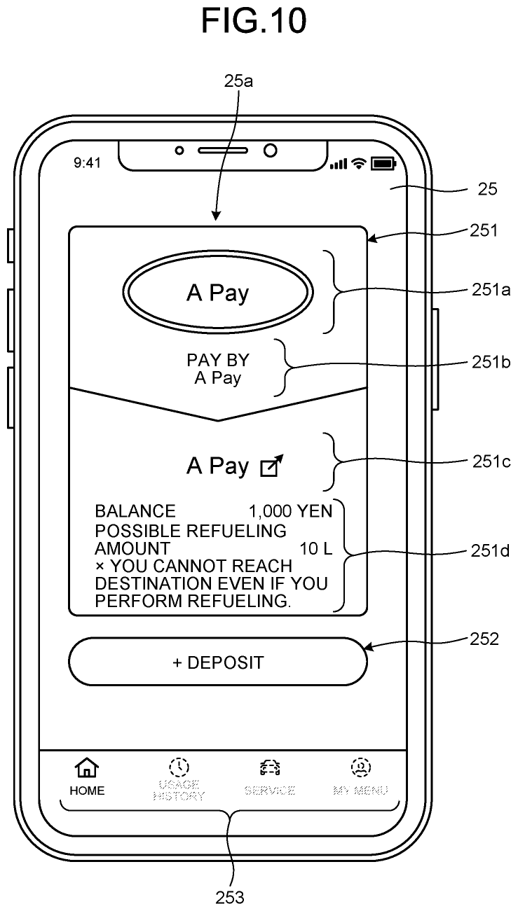

Furthermore, the display controller 211 may display characters of “You can reach the destination if you perform refueling.” illustrated in FIG. 9 and characters of “You cannot reach the destination even if you perform refueling.” illustrated in FIG. 10 on the additional information region 251d as information indicating whether or not the preset destination may be reached if the vehicle is refueled with gasoline of an amount obtained by converting the balance into gasoline. As a result, the user may preliminarily know whether he/she may reach the destination, so that the convenience is improved. Note that the destination may be determined by reading data input to a car navigation system, or may be input by the user. Then, whether or not the destination may be reached may be determined by calculating the distance between the destination and the current position and determining whether or not the calculated distance is larger than the travelable distance after refueling. The current position is determined by position information of the user terminal 2 calculated by a GPS.

The charge button 252 is used to perform depositing to electronic money. When the user pushes the charge button 252, a preset and predetermined amount of money may be deposited, or transition may be performed to a screen for selecting a depositing means such as a credit card and a bank account.

The menu switching region 253 is used for switching menu items. In the examples illustrated in FIGS. 4 to 10, home, usage history, service, and my menu are exhibited as the menu items. “Home” is a menu item for displaying the settlement screen 25a.

As described above, according to the settlement program, the settlement system, and settlement server of the embodiment, information obtained by converting the balance of the registered prepaid-type settlement method into an energy source is displayed, so that the convenience is improved.

For example, a settlement system including the settlement server according to the embodiment may be used for electronic commerce on the Internet in addition to face-to-face settlements at real stores, such as electronic money payments, scan payments, and code payments, as illustrated in FIG. 3.

Furthermore, in the case where the user terminal 2 is a car navigation system mounted on a vehicle, the settlement system including the settlement server according to the embodiment may be used for a settlement made while the vehicle is driving.

According to the disclosure, the convenience of a settlement system using a prepaid-type settlement method may be improved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium on which an executable program is recorded, the program causing a processor of a computer to execute:
displaying, on a display, information obtained by converting a balance of a registered prepaid-type settlement method into an amount of an energy source used in life.

2. The non-transitory computer-readable recording medium according to claim 1, wherein the information relates to an amount obtained by converting the balance into the energy source.

3. The non-transitory computer-readable recording medium according to claim 1, wherein the information relates to a distance which a moving object is allowed to move in a case where the moving object is refueled with the energy source of an amount obtained by converting the balance into the energy source.

4. The non-transitory computer-readable recording medium according to claim 1, wherein the information relates to a filling rate of a tank of a moving object in a case where the moving object is refueled with the energy source of an amount obtained by converting the balance into the energy source.

5. The non-transitory computer-readable recording medium according to claim 1, wherein the information relates to whether or not a preset destination is allowed to be reached in a case where a moving object is refueled with the energy source of an amount obtained by converting the balance into the energy source.

6. The non-transitory computer-readable recording medium according to claim 1, wherein the program causes the processor to execute:
acquiring a unit price of the energy source in a store in which the energy source is allowed to be bought; and
converting the balance into an amount of an energy source by using the unit price.

7. The non-transitory computer-readable recording medium according to claim 1, wherein the energy source includes gasoline, hydrogen, electricity, and gas.

8. A settlement system comprising:
a settlement server comprising
a first processor comprising hardware, the first processor being configured to display, on a display, information obtained by converting a balance of a registered prepaid-type settlement method into an amount of an energy source used in life; and
a terminal comprising
a second processor comprising hardware, and
the display.

9. The settlement system according to claim 8, wherein the information relates to an amount obtained by converting the balance into the energy source.

10. The settlement system according to claim 8, wherein the information relates to a distance which a moving object is allowed to move in a case where the moving object is refueled with the energy source of an amount obtained by converting the balance into the energy source.

11. The settlement system according to claim 8, wherein the information relates to a filling rate of a tank of a moving object in a case where the moving object is refueled with the energy source of an amount obtained by converting the balance into the energy source.

12. The settlement system according to claim 8, wherein the information relates to whether or not a preset destination is allowed to be reached in a case where a moving object is refueled with the energy source of an amount obtained by converting the balance into the energy source.

13. The settlement system according to claim 8, wherein the first processor is configured to
acquire a unit price of the energy source in a store in which the energy source is allowed to be bought, and
convert the balance into an amount of an energy source by using the unit price.

14. The settlement system according to claim 8, wherein the energy source includes gasoline, hydrogen, electricity, and gas.

15. A server comprising
a processor comprising hardware, the processor being configured to display, on a display, information obtained by converting a balance of a registered prepaid-type settlement method into an amount of an energy source used in life.

16. The server according to claim 15, wherein the information relates to an amount obtained by converting the balance into the energy source.

17. The server according to claim 15, wherein the information relates to a distance which a moving object is allowed to move in a case where the moving object is refueled with the energy source of an amount obtained by converting the balance into the energy source.

18. The server according to claim 15, wherein the information relates to a filling rate of a tank of a moving object in a case where the moving object is refueled with the energy source of an amount obtained by converting the balance into the energy source.

19. The server according to claim 15, wherein the information relates to whether or not a preset destination is allowed to be reached in a case where a moving object is refueled with the energy source of an amount obtained by converting the balance into the energy source.

20. The server according to claim 15, wherein the processor is configured to
acquire a unit price of the energy source in a store in which the energy source is allowed to be bought, and
convert the balance into an amount of an energy source by using the unit price.
